(19) United States
(12) Patent Application Publication
(10) Pub. No.: US 2018/0183690 A1
(43) Pub. Date: Jun. 28, 2018

(54) INFORMATION PROCESSING APPARATUS FOR ACQUIRING LOG AND METHOD OF CONTROLLING INFORMATION PROCESSING APPARATUS THEREFOR

(71) Applicant: FUJITSU LIMITED, Kawasaki-shi (JP)

(72) Inventors: Haruki Yamanashi, Kawasaki (JP); Koji Nakazono, Yokohama (JP); Sayako Kondoh, Yokohama (JP)

(73) Assignee: FUJITSU LIMITED, Kawasaki-shi (JP)

(21) Appl. No.: 15/824,203

(22) Filed: Nov. 28, 2017

(30) Foreign Application Priority Data
Dec. 28, 2016 (JP) 2016-255844

(51) Int. Cl. H04L 12/26; H04L 12/24; H04L 29/08

(52) U.S. Cl. CPC H04L 43/04; H04L 67/10; H04L 41/069

(57) ABSTRACT

It is provided an information processing apparatus configured to acquire logs regarding processes executed by a plurality of nodes. The information processing apparatus includes memory and a processor configured to execute: receiving identification information for identifying the processes, acquiring from the plurality of nodes first time information including time when a first process of the processes indicated by the received identification information is executed and time when a failure occurs during the first process, and acquiring from the plurality of nodes a first log regarding a process different from the first process, the first log being generated during a time period determined based on the time when the first process is executed and the time when the failure occurs during the first process.

### CROSS-REFERENCE TO RELATED APPLICATIONS

This application is based upon and claims the benefit of priority of the prior Japanese Patent Application No. 2016-255844, filed on Dec. 28, 2016, the entire contents of which are incorporated herein by reference.

### FIELD

The embodiments discussed herein are related to an information processing apparatus configured to acquire logs regarding failures occurred in an information processing system and a method of controlling an information processing apparatus for acquiring logs regarding failures occurred in an information processing system.

### BACKGROUND

When a failure occurs during a series of processes executed by a combination of plural nodes such as computers in an information processing system. The nodes are connected with each other and logs regarding the operations of the nodes are gathered from the nodes.

A technique for increasing accuracy of diagnoses of the failures based on the gathered logs in the information processing apparatus is proposed (See patent document 1). A technique for estimating factors of the failures based on the logs which have been gathered in the system is also proposed (See patent document 2).

The following patent documents describe conventional techniques related to the techniques described herein.

[Patent Document]

[Patent document 1] Japanese Laid-open Patent Publication No. 2010-117757

[Patent document 2] Japanese Laid-open Patent Publication No. 2009-252006

### SUMMARY

According to one embodiment, it is provided an information processing apparatus configured to acquire logs regarding processes executed by a plurality of nodes. The information processing apparatus includes memory and a processor configured to execute: receiving identification information for identifying the processes, acquiring from the plurality of nodes first time information including time when a first process of the processes indicated by the received identification information is executed and time when a failure occurs during the first process, and acquiring from the plurality of nodes a first log regarding a process different from the first process, the first log being generated during a time period determined based on the time when the first process is executed and the time when the failure occurs during the first process.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a diagram schematically illustrating an example of a configuration of an information processing system according to an embodiment;

FIG. 2 is a diagram schematically illustrating an example of a configuration of an information processing apparatus according to an embodiment;

FIG. 3 is a diagram schematically illustrating an example of a log output in an information processing system according to an embodiment;

FIG. 4 is a diagram schematically illustrating an example of a server management table stored in a management server according to an embodiment;

FIG. 5 is a diagram schematically illustrating an example of a log reception status management table stored in a management server according to an embodiment;

FIG. 6 is a diagram schematically illustrating an example of a log management table stored in a server sv-1 according to an embodiment;

FIG. 7 is a diagram schematically illustrating an example of a log management table stored in a server sv-2 according to an embodiment;

FIG. 8 is a diagram schematically illustrating an example of a log management table stored in a server sv-3 according to an embodiment;

FIG. 9 is a diagram schematically illustrating an example of a log management table stored in a server sv-4 according to an embodiment;

FIG. 10 is a diagram schematically illustrating an example of a log management table stored in a management server according to an embodiment;

FIG. 11 is a diagram illustrating an example of a flowchart of processes for finding an error log executed by a server according to an embodiment;

FIG. 12 is a diagram illustrating an example of a flowchart of processes for storing information of an error log executed by a management server according to an embodiment;

FIG. 13 is a diagram illustrating an example of a flowchart of processes for acquiring and storing information of an error log executed by a management server according to an embodiment;

FIG. 14 is a diagram illustrating an example of a flowchart of processes for transmitting information of an error log executed by a server according to an embodiment;

FIG. 15 is a diagram illustrating an example of a flowchart of processes for acquiring and storing a log output in a predetermined time period executed by a management server according to an embodiment;

FIG. 16 is a diagram illustrating an example of a flowchart of processes executed by a management server after processes in FIG. 15 are executed according to an embodiment;

FIG. 17 is a diagram illustrating an example of a flowchart of processes for transmitting a request ID of an error log executed by a server according to an embodiment;

FIG. 18 is a diagram schematically illustrating an exemplary case according to an embodiment;

FIG. 19 is a diagram illustrating an example of a flowchart of processes for acquiring and storing a log of a resource related to an error executed by a management server according to an embodiment;

FIG. 20 is a diagram illustrating an example of a flowchart of processes executed by a management server subsequent to processes in FIG. 19 are executed according to an embodiment; and

FIG. 21 is a diagram schematically illustrating an exemplary case which is different from the case in FIG. 18 according to an embodiment.

### DESCRIPTION OF EMBODIMENTS

First, an information processing apparatus according to an embodiment is described below with reference to the drawings. The configurations of the following embodiments are mere exemplifications, and the present apparatus is not limited to any of the configurations of the embodiments.

FIG. 1 schematically illustrates an example of a configuration of an information processing system 1 according to an embodiment. The information processing system 1 includes a management server 2, a server 3, a server 4 and a network 5. The management server 2, the servers 3, 4 are connected with each other via the network 5. The network 5 is a wired or wireless communication network. In addition, the information processing system 1 is connected with a client terminal 6 via the network 5. It is noted that each server in the information processing system 1 is an example of a node.

The management server 2, the server 3 and the server 4 include a database 21, 31, 41, respectively. In the present embodiment, the management server 2, the server 3 and the server 4 store a variety of logs generated in the own server in the database 21, 31, 41, respectively. The number of the management server 2, the number of the servers 3, 4, the number of the network 5 and the number of the client terminal 6 are not limited to the numbers illustrated in FIG. 1.

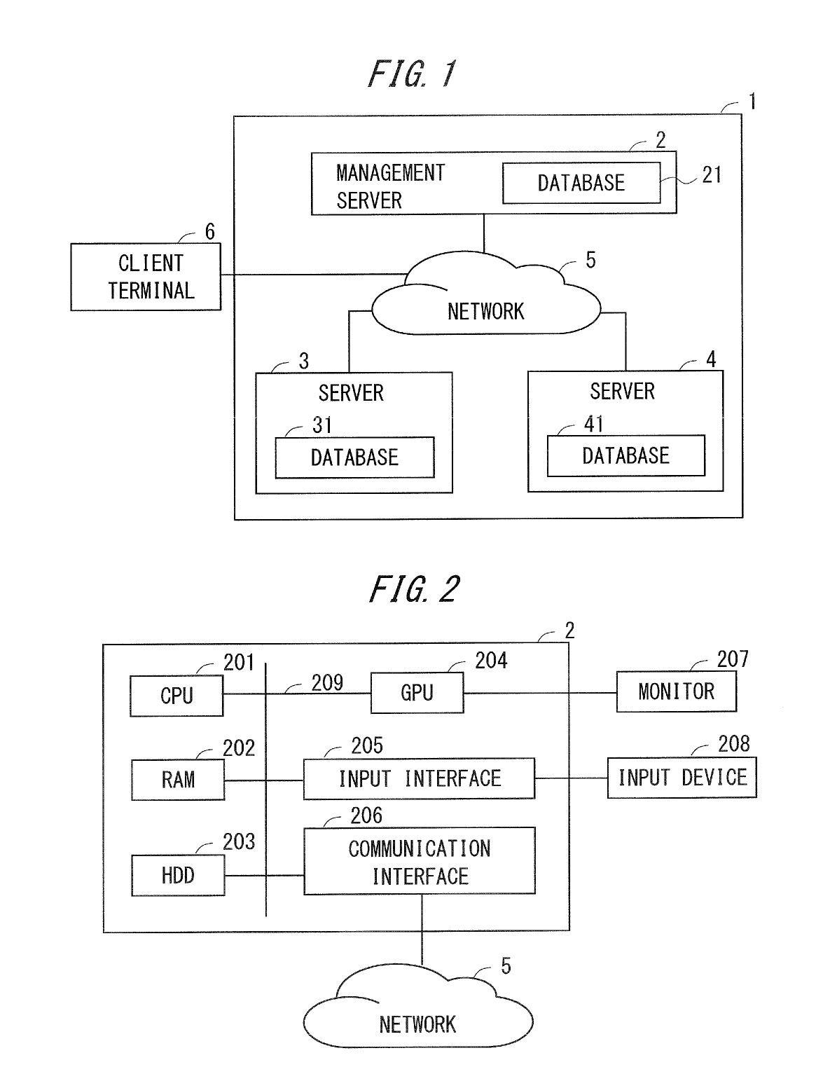

FIG. 2 illustrates an example of a configuration of the management server 2. The management server 2 includes a Central Processing Unit (CPU) 201, Random Access Memory (RAM) 202, a Hard Disk Drive (HDD) 203, a Graphics Processing Unit (GPU) 204, an input interface 205 and a communication interface 206. The HDD 203 functions as a database 21. In addition, the GPU 204, the input interface 205 and the communication interface 206 are connected with a monitor 207, an input device 208 and the network 5, respectively. The CPU 201, the RAM 202, the HDD 203, the GPU 204, the input interface 205 and the communication interface 206 are connected with each other via a bus 209.

In the present embodiment, the CPU 201 executes a variety of processes as described below by deploying a variety of programs stored in the HDD 203 on the RAM 202 and executing the deployed programs.

In an example of the present embodiment, when the client terminal 6 transmits an instruction to execute a process to a server in the information processing system 1, the server attaches a request ID to a series of processes executed according to the instruction. The request ID uniquely identifies the series of processes. A Universally Unique Identifier (UUID) can be used as an example of the request ID. Each server in the information processing system 1 inherits the attached request ID when each server transmits and/or receives requests and responses related to the series of processes. In OPENSTACK (Registered Trademark), for example, which is cloud management software, when a network is configured after an instance is generated in an information processing system, the same request ID is attached to a series of processes related to the configuration of the network. It is assumed, for example, that a node A, a node B and a node C are included in an information processing system, the node A receives an instruction to generate an instance from a client terminal, the node A requests the node B for configuring a network, and then the node B requests the node C for configuring the network. In this case, the same request ID is attached to each process executed by the node A, the node B and the node C.

In addition, it is assumed in the present embodiment that a resource ID is attached to each resource in the information processing system 1. A UUID can be used as an example of the resource ID. In the OPENSTACK, for example, a resource ID is attached to each resource on the cloud such as a server and a disk in an information processing system. It is assumed, for example, that a management server, a server A and a disk connected with the server A are included in an information processing system, and the management server receives a request for removing the disk from a client terminal. In this case, a log related to the request for removing the disk which the management server receives from the client terminal, a log related to a request for removing the disk which the management server requests the server A, and a log related to a process for removing the disk executed by the server A are generated. And the resource IDs of the server A and the disk are output to each of the logs.

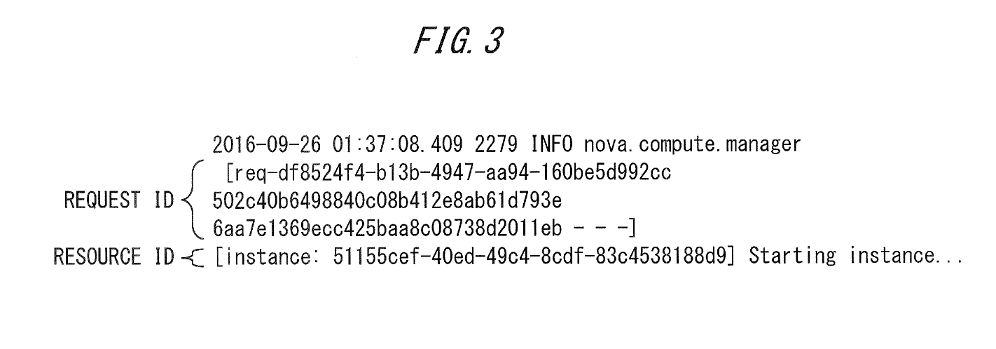

FIG. 3 illustrates an example of a part of a log generated for a series of processes executed in the information processing system 1. As illustrated in FIG. 3, the log includes attached request IDs and resource IDs of resources related to the series of processes. The request ID is, for example, generated as a UUID which uniquely identifies processes executed in the information processing system 1 based on the dominical year and the day and time information. In addition, the resource ID is, for example, generated as a UUID which uniquely identifies a resource in the information processing system 1. It is noted in the following descriptions that a log means a combination of information including a message representing a content of the log (“Starting instance . . . ” in the case in FIG. 3), a day and time when the log is output, a request ID and a resource ID. Therefore, a content of a log, the day and time when the log is output, a request ID of a series of processes corresponding to the log and a resource ID of a resource related to the series of processes can be determined by the log.

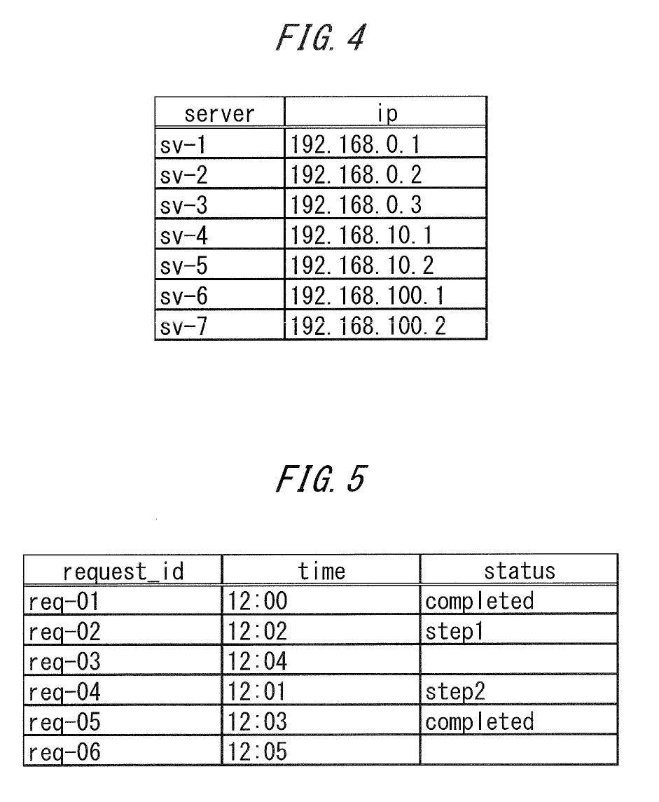

FIG. 4 illustrates an example of a server management table stored in the database 21 in the management server 2. In the present embodiment, different IP addresses are allocated to different servers in the information processing system 1. The name of each server in the information processing system 1 is stored in the “server” column and the IP address allocated to each server is stored in the “ip” column in the server management table in FIG. 4. In the present embodiment, the management server 2 uses the IP addresses stored in the server management table to execute processes including requests for logs of the servers in the information processing system 1. In the example in FIG. 4, there are seven servers in the information processing system 1 and the name of each server is sv-1, sv-2, sv-3, sv-4, sv-5, sv-6 or sv-7.

FIG. 5 illustrates an example of a log reception status management table stored in the database 21 in the management server 2. In the present embodiment, the management server 2 stores information of reception statuses of logs from the servers in the information processing system 1 in the log reception status management table. Each entry in the log reception status management table corresponds to each request ID. For example, each entry includes information of the “request_id” column, the “time” column and the “status” column. The “request_id” column in the log reception status management table in FIG. 5 stores request IDs attached to processes executed in the information processing system 1. The “time” column stores times when error logs are output. The “status” column stores statuses which indicate reception statuses of logs. In the present embodiment, the reception statuses of logs include “step1”, “step2” and “completed”. The management server 2 uses the information stored in the log reception status management table to execute processes for receiving logs corresponding to the request IDs.

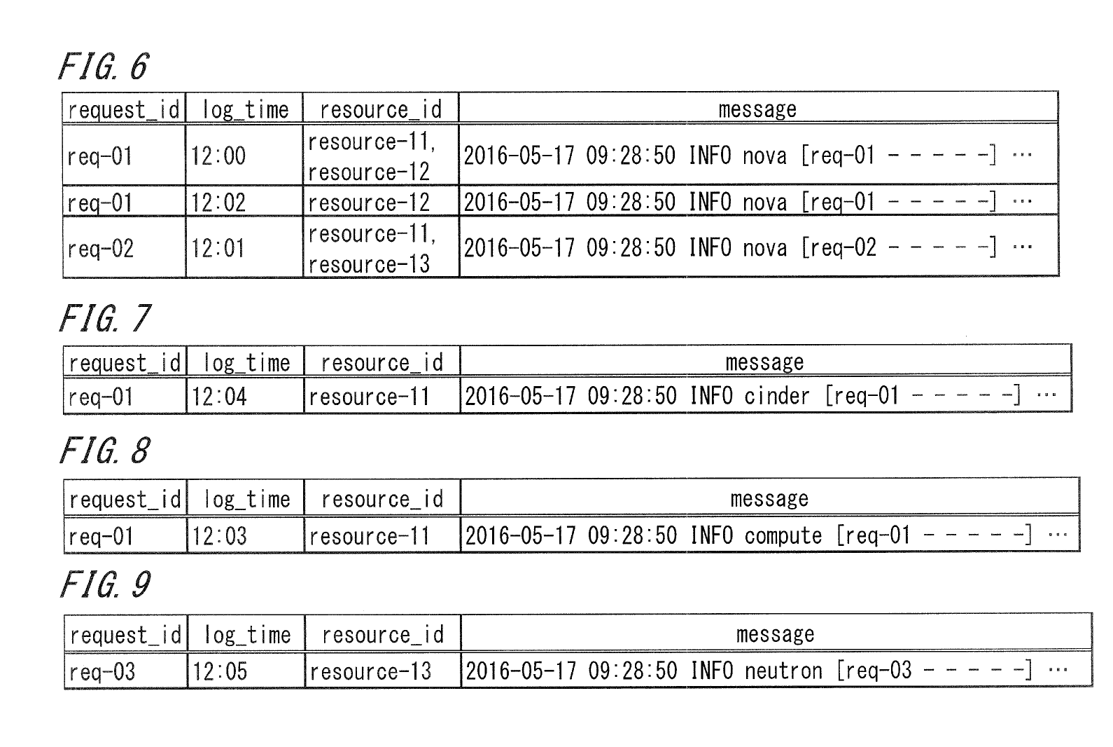

FIGS. 6 to 9 illustrate examples of log management tables stored in the database in each server in the information processing system 1. FIGS. 6, 7, 8 and 9 illustrate information stored in the log management tables in the servers sv-1, sv-2, sv-3 and sv-4 in the information processing system 1, respectively. The “request_id” columns in the log management tables in FIGS. 6 to 9 store the request IDs attached to the processes executed in the information processing system 1, similar to the log reception status management table as described above. In addition, the “log_time” column stores times when logs are output. Further, the “resource_id” stores one or more resource IDs of one or more resources related to a series of processes corresponding to the request ID.

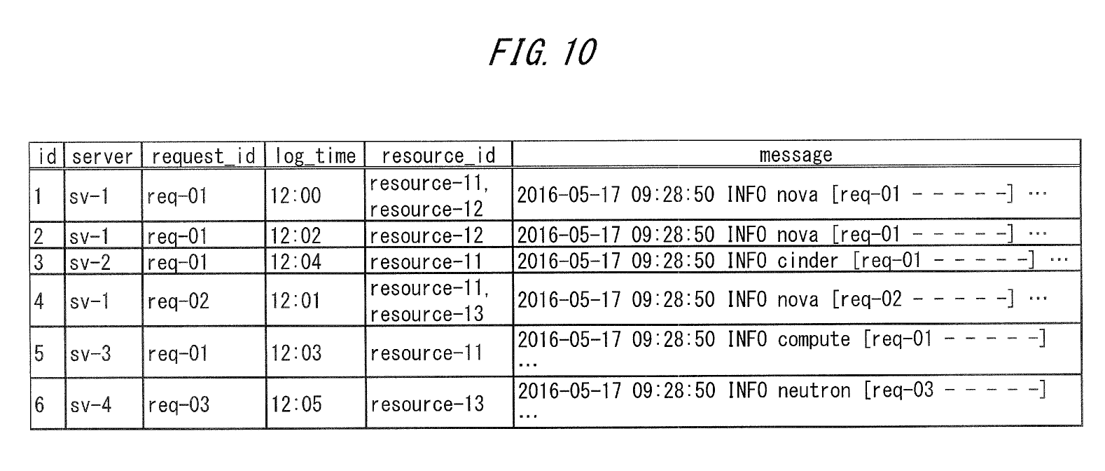

FIG. 10 illustrates an example of a log management table stored in the database 21 in the management server 2. In the present embodiment, the management server 2 receives logs from the servers in the information processing system 1, and stores information included in the received logs in the log management table. The “id” column in the log management table in FIG. 10 stores identifiers for identifying each log. The identifiers stored in the “id” column are attached to the logs by the management server 2. In addition, the information stored in the “server” column, the “request_id” column, the “log_time” column, the “resource_id” column and the “message” column is similar to the information stored in the corresponding columns as described above.

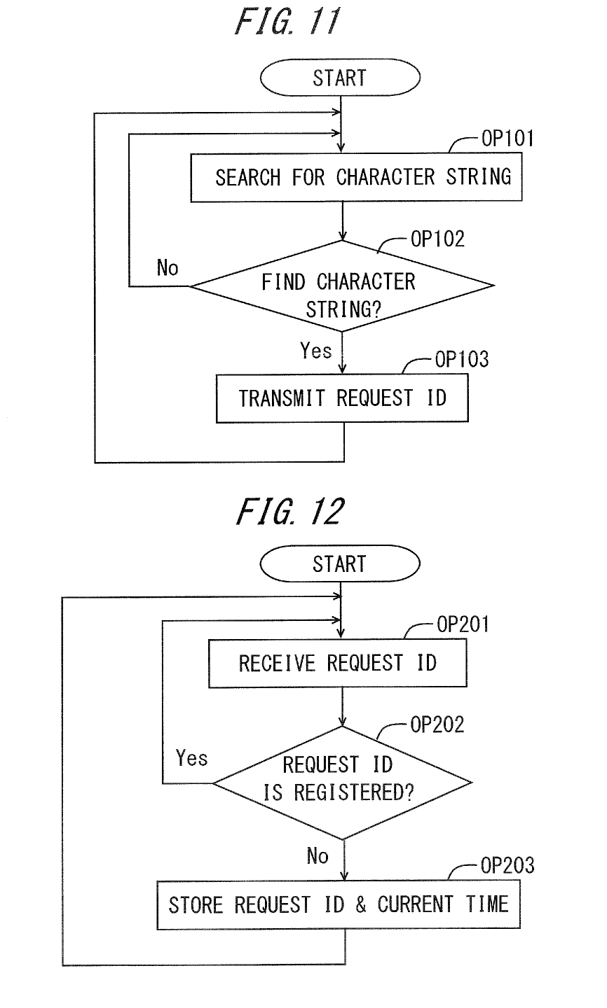

Next, processes executed by the management server 2 and the servers 3, 4 in the present embodiment are described below with reference to flowcharts. FIG. 11 illustrates an example of a flowchart of processes executed by the CPUs of the servers 3, 4. For example, the CPUs of the servers 3, 4 initiate agents to start the execution of the processes in the flowchart in FIG. 11 when the servers 3, 4 are powered on. In OP101, the agents initiated upon the power-on of the servers 3, 4 use predetermined character strings as keywords to execute search in one of the logs generated in the servers in which the agents reside. The character strings include strings which may be used in error logs such as “error”, “warning” and “failure” etc.

Next, the agents determine in OP102 whether any of the predetermined character strings used in OP101 is found in the logs. When any of the predetermined character strings used in OP101 is found in the logs (OP102: Yes), the process proceeds to OP103. On the other hand, when the predetermined character strings used in OP101 are not found in the logs (OP102: No), the agents return the process to OP101 to execute the character string search as described above for another log for which the search has not been executed.

In OP103, the agents transmits a request ID corresponding to the log in which any of the character strings used as the keywords is found to the management server 2. When the agents completes the process in OP103, the agents return the process to OP101 to execute the character string search as described above for another log for which the search has not been executed.

FIG. 12 illustrates an example of a flowchart of processes executed by the CPU 201 of the management server 2. For example, the CPU 201 starts to execute the processes in the flowchart in FIG. 12 when the management server 2 is powered on. In OP201, the CPU 201 functions as a receiving unit to receive the request ID transmitted in OP103 from the server 3 or the server 4. Next, the process proceeds to OP202.

In OP202, the CPU 201 determines whether the received request ID is stored in the log reception status management table. When the received request ID is stored in the log reception status management table (OP202: Yes), the CPU 201 returns the process to OP201 to receive a new request ID from the server 3 or the server 4. On the other hand, when the received request ID is not stored in the log reception status management table (OP202: No), the process proceeds to OP203.

In OP203, the CPU 201 stores the received request ID and the current time in the log reception status management table. When the CPU 201 completes the process in OP203, the CPU 201 returns the process to OP201 to receive a new request ID from the server 3 or the server 4. In the present embodiment, when a failure related to a series of processes executed in the information processing system 1 occurs, the management server 2 can acquire information such as a request ID relate to the failure by executing the above processes.

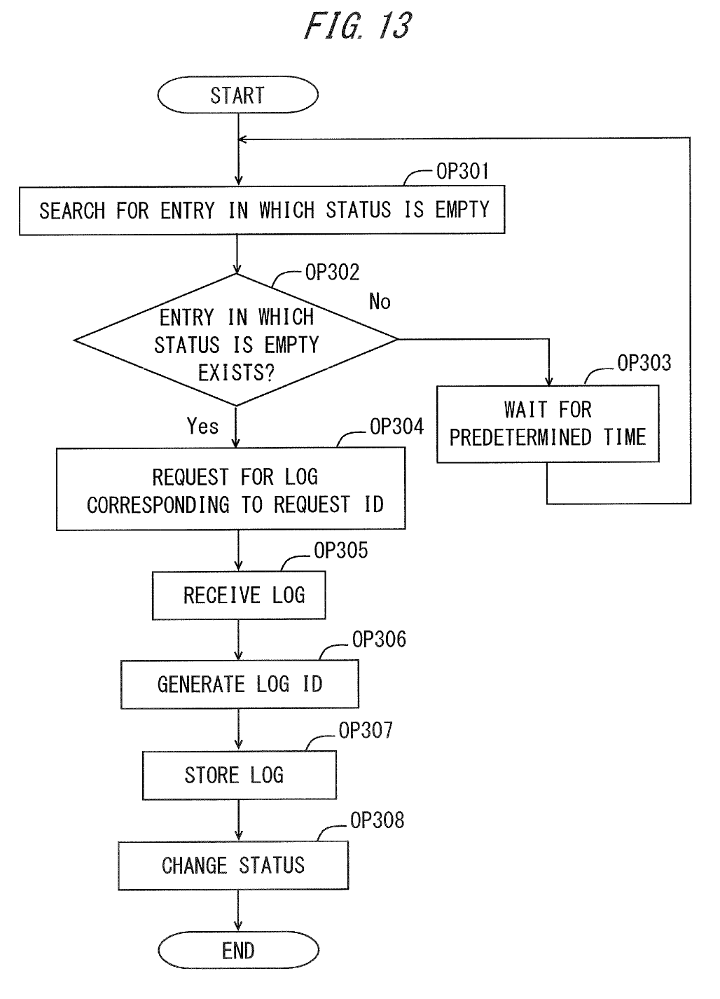

FIG. 13 illustrates an example of a flowchart of processes executed by the CPU 201 of the management server 2. The management server 2 executes the processes in FIG. 13 separately from the processes in FIG. 12. Alternatively, the management server 2 can execute the processes in FIG. 13 in parallel with the processes in FIG. 12.

In OP301, the CPU 201 searches for an entry in which the “status” column is empty in the log reception status management table. It is noted that the fact that the “status” column is empty means that although the management server 2 has executed the processes in FIG. 12 to acquire a request ID of the process in which a failure occurs, the management server 2 has not acquired other information including a log corresponding to the acquired request ID. Next, in OP302, the CPU 201 determines based on the result of the above search whether an entry in which the “status” column is empty exists in the log reception status management table. When an entry in which the “status” column is empty exists (OP302: Yes), the process proceeds to OP304. On the other hand, when an entry in which the “status” column is empty does not exist (OP302: No), the process proceeds to OP303.

IN OP303, the CPU 201 waits for a predetermined time period and then the CPU 201 returns the process to OP301. For example, when a process related to a request ID transmitted from the server 3 or the server 4 to the management server 2 in the processes in FIG. 11 is a retry process due to a system timeout, the server 3 or the server 4 records the process as an error in the log every time the server 3 or the server 4 executes the process. Therefore, the management server 2 may receive in OP201 the request ID related to the error from the server 3 or the server 4 repeatedly. In the present embodiment, since the CPU 201 waits for the predetermined time period and executes the process in OP301, the possibility that the management server 2 receives in OP201 the same request ID from the server 3 or the server 4 repeatedly due to a retry process related to a system timeout can be decreased. Time period which is longer than the time period of the system timeout of the server 3 or the server 4 in the information processing system 1 can be used as the predetermined time period as described above.

In OP304, the CPU 201 requests the server 3 or the server 4 to transmit a log corresponding to the request ID for which the CPU 201 determines in P302 that the “status” column is empty to the management server 2. In an example in the present embodiment, the management server 2 multicasts the request to each server in the information processing system 1. However, the management server 2 can use the information stored in the server management table to transmit the request to a specific server in the information processing system 1.

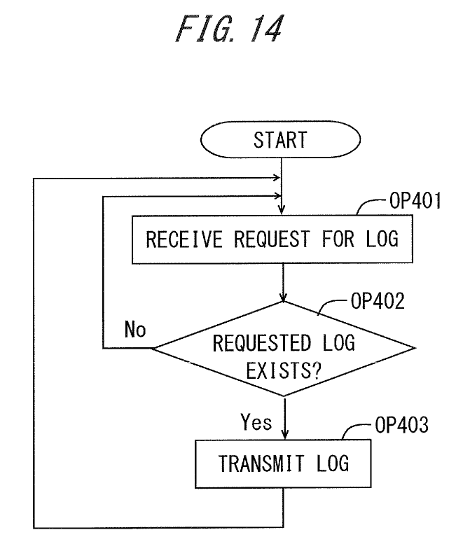

The processes executed by an agent in the server 3 or the server 4 which receives from the management server 2 a request for transmitting a log in OP304 are described below with reference to FIG. 14. In OP401, the agent in the server 3 or the server 4 receives the request for transmitting the log transmitted from the management server 2 in OP304. In OP402, the agent in the server 3 or the server 4 searches in the database 301 or the database 401 to determine whether a log corresponding to the request ID related to the request exists. When the agent determines that the log exists (OP402: Yes), the process proceeds to OP403. When the agent determines that the log does not exist (OP402: No), the agent returns the process to OP401 to wait for a new request for transmitting a log from the management server. In OP403, the agent in the server 3 or the server 4 acquires the log which exists in the database 301 or the database 401 and transmits the log to the management server 2.

Referring to FIG. 13, the CPU 201 of the management server 2 functions as an information acquiring unit in OP305 to receive a log for which the CPU 201 requests the server 3 or the server 4 in OP304. And the process proceeds to OP306. In OP306, the CPU 201 uses a message included in the received log to generate a hush value and determines the generated hush value as a log ID for the received log. Next, in OP307, the CPU 201 stores the information included in the log received in OP305 and the log ID generated in OP306 in the log management table. In the example of the log management table in FIG. 10, the CPU 201 stores the information included in the log received in OP305 in the “server” column, the “request_id” column, the “log_time” column, the “resource_id” column and the “message” column. In addition, the CPU 201 stores the log ID generated in OP306 in the “id” column. When the same log ID has been already stored in the log management table, the CPU 201 skips the process for storing the information in the table and the process proceeds to OP308.

Further, in OP308, the CPU 201 changes the status of the “status” column for the entry corresponding to the request ID for which the CPU 201 determines in OP302 that the “status” column is empty from empty to “step1”. It is noted that the status “step1” indicates that the management server 2 has received from a server in the information processing system 1 a log related to the request ID received in the processes in FIGS. 11 and 12,that is, the request ID for the processes in which a failure occurs.

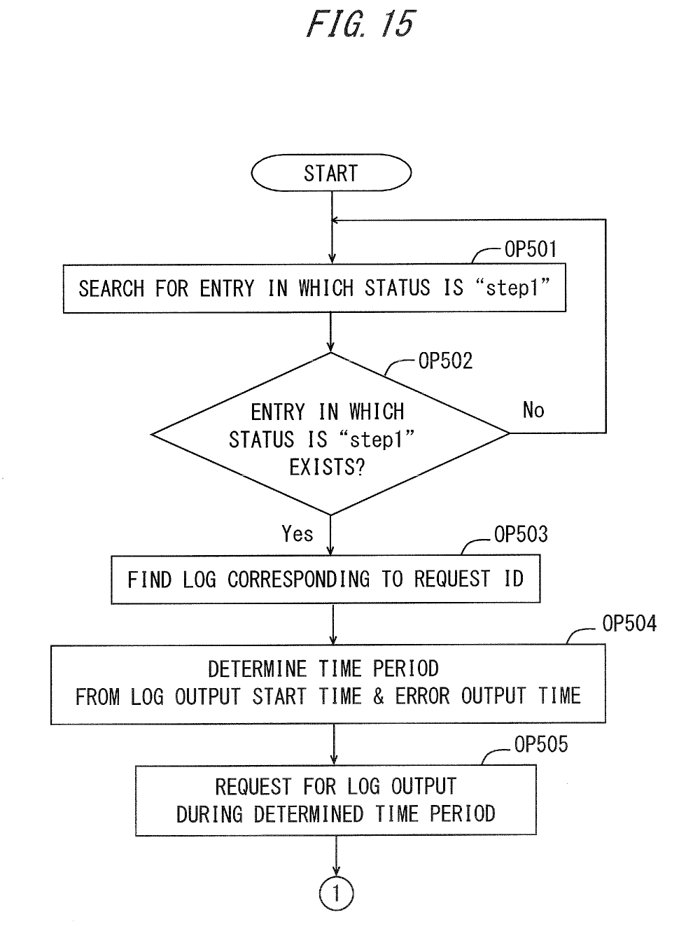

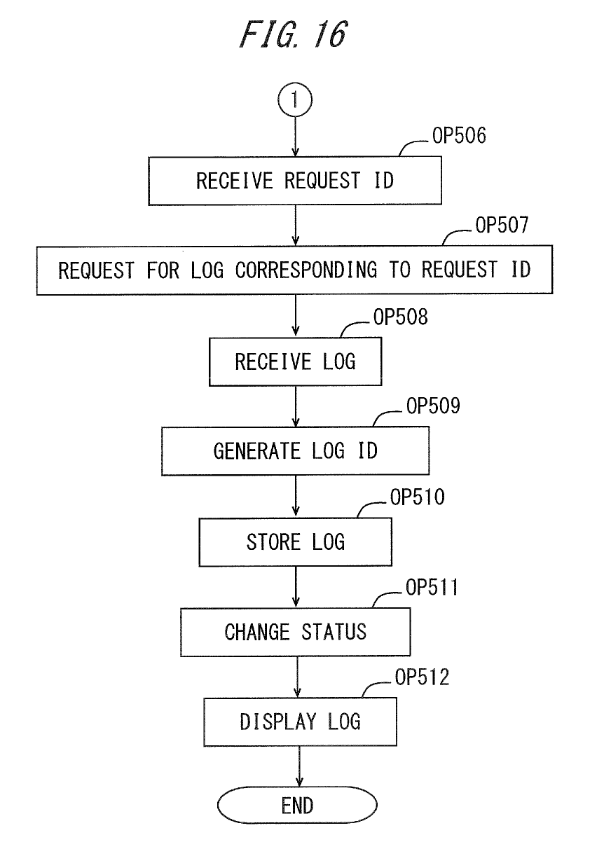

Next, FIGS. 15 and 16 illustrate flowcharts of processes executed by the CPU 201 of the management server 2. The management server 2 executes the processes in FIGS. 15 and 16 separately from the processes in FIGS. 12 and 13. Alternatively, the management server 2 can execute the processes in FIGS. 12, 13, 15 and 16 in parallel.

In OP501, the CPU 201 searches for an entry in which the “status” column indicates “step1” in the log reception status management table. Next, in OP502, the CPU 201 determines whether an entry in which the “status” column indicates “step1” exists in the log reception status management table. When an entry in which the “status” column indicates “step1” exists (OP502: Yes), the process proceeds to OP503. On the other hand, when an entry in which the “status” column indicates “step1” does not exist (OP502: No), the CPU 201 returns the process to OP501.

In OP503, the CPU 201 searches the log management table to find a log corresponding to the request ID for which the CPU 201 determines in OP502 that the “status” column indicates “step1”. Next, in OP504, the CPU 201 determines from the information of the log found in OP503 output start time of the log and time when the log is output. It is noted that the output start time of the log means time when the log found in OP503 is output, that is, the earliest time among the times in the “log_time” column for the log in the log management table. Other times such as a time every 10 minutes etc. close to the earliest time can be used for the output start time of the log. Further, the time when the log is output means a time in the “log_time” column for the log for which the “message” column in the log management table includes a character string used for the search for an error log by the server 3 or the server 4 in OP101.

Moreover, in OP504, the CPU 201 determines a time period ranging from the output start time of the log to the time when the log is output. It is assumed here, for example, that when the information stored in the log management table is the information as illustrated FIG. 10, the CPU 201 determines the time period ranging from the output start time of the log corresponding to the request ID “req-01” to the time when the log is output. In addition, it is also assumed that the log in which the “id” column is “05” is an error log. In this case, the earliest time among the times in the “log_time” column of the log corresponding to the request ID “req-01” is “12:00” for which the “id” column is “01”. Therefore, the output start time of the log is “12:00”. In addition, the time in the “log time” column for which the “id” column is “05” is “12:03”. Therefore, the time when the error log is output is “12:03”. As a result, the time period ranging from 12:00 to 12:03 is determines as the time period in OP504.

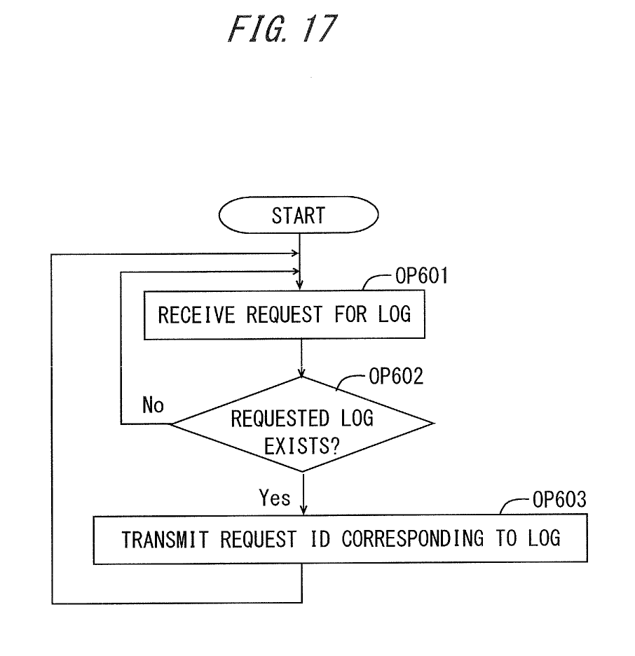

Next, in OP505, the CPU 201 requests the server 3 and the server 4 for transmitting logs corresponding to request IDs other than the request ID used to determine the time period in the above processes among the logs output during the determined time period to the management server 2. The agents in the server 3 and the server 4 execute the processes in the flowchart in FIG. 17. The agents in the server 3 and the server 4 receive a request from the management server 2 for transmitting logs during the time period determined in OP504 to the management server 2 (OP601). And the agents determine whether a log output during the time period specified in the request exists (OP602). And then, when a log output during the time period specified in the request exists, the agents transmit the request ID corresponding to the log which the agents determine exists to the management server 2.

When the CPU 201 of the management server 2 receives in OP506 a request ID of the log which the CPU 201 requests the server 3 and the server 4 for transmitting to the management server 2, the process proceeds to OP507. In OP507, the CPU 201 requests the server 3 and the server 4 for transmitting a log corresponding to the received request ID to the management server 2. The agents in the server 3 and the server 4 execute processes similar to the processes in the flowchart in FIG. 14. The agents in the server 3 and the server 4 receive from the management server 2 a request for transmitting a log corresponding to the log to the management server 2 (OP401). And the agents determine whether a log corresponding to the request ID specified in the request exists. And then, when a log corresponding to the request ID specified in the request exists, the agents transmit the log which the agents determine exists to the management server 2 (OP403).

Referring to FIG. 16, when the CPU 201 of the management server 2 functions as a log acquiring unit to receive in OP508 a log which the CPU 201 request the server 3 and the server 4 for transmitting, the process proceeds to OP509. In OP509, the CPU 201 uses messages included in the received log to generate a hush value and determines the generated hush value as a log ID of the log. Next, in OP510, the CPU 201 executes processes similar to OP307 to store the information included in the log received in OP508 and the log ID generated in OP509 in the log management table.

In addition, the CPU 201 changes the status in the “status” column for the request ID for which the CPU 201 determines in OP502 that the “status” column is “step1” from “step1” to “step2” in the log reception status management table. The status “step2” means that the management server 2 has acquired from a server in the information processing system a log output during the time period determined in OP504. And, in OP512, the CPU 201 displays the information of the log stored in the log management table in OP510 on the monitor 207.

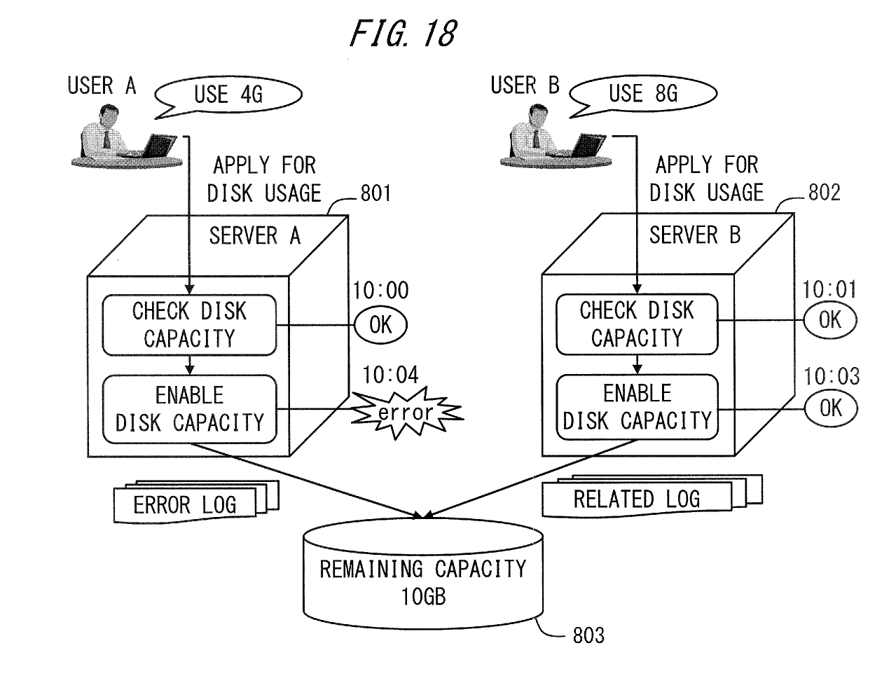

FIG. 18 illustrates an example of a case in which the management server 2 acquires a log when processes in FIGS. 15 to 17 are executed in the present embodiment. In the example as illustrated in FIG. 18, the information processing system 1 includes a server A 801, a server B 802, a database 803 (remaining capacity: 10 GB) and the management server 2 (not illustrated). It is assumed here that a user A operates a client terminal to apply to the server A 801 for disk usage of the database 803 of 4 GB of the remaining capacity. In addition, a user B also operates a client terminal to apply to the server B for disk usage of the database 803 of 8 GB of the remaining capacity. It is assumed here that the user A applies for the disk usage earlier than the user B.

The server A 801 receives the application of the disk usage from the user A and checks the disk capacity of the database 803 at 10:00. And the server A 801 outputs a log of the process for checking the disk capacity. On the other hand, the server B 802 receives the application of the disk usage from the user B and checks the disk capacity of the database 803 at 10:01. And the server B 802 outputs a log of the process for checking the disk capacity.

It is further assumed that the server B 802 executes a process for enabling the disk capacity applied from the user B earlier than the server A 801. In this case, since the remaining capacity of the database 803 is 10 GB, the process for enabling the disk capacity of 8 GB executed by the server B 802 is completed normally. And the server B 802 outputs and stores a log of the process for enabling the disk capacity. On the other hand, ab error occurs in the process for enabling the disk capacity of 4 GB executed by the server A 801 at 10:04 since the remaining capacity is 2 GB. And the server A 801 outputs and stores an error log of the error.

In the example in FIG. 18, the process for checking the disk capacity and the process for enabling the disk capacity which are executed by the server A 801 are attached with a common request ID. Also, the process for checking the disk capacity and the process for enabling the disk capacity which are executed by the server B 802 are attached with a common request ID. In addition, as a result of the processes in FIGS. 15 to 17, the management server 2 acquires from the server A 801 the error log of the error output by the server A 801 at 10:04 and the log of the process for checking the disk capacity output by the server A 801 at 10:00. Further, the management server 2 acquires from the server B 802 the log of the process for checking the disk capacity output from 10:00 to 10:04 (output at 10:03 in the present example) and the log of the process for enabling the disk capacity (output at 10:03 in the present example). In the example in FIG. 18 as described above, a log of a process executed by the other server B 802 during a time period during which a series of processes are executed by the server A 801 can be acquired. Namely, the management server 2 can acquire a log which is likely to be related to a failure occurred in a server from another server in the information processing system.

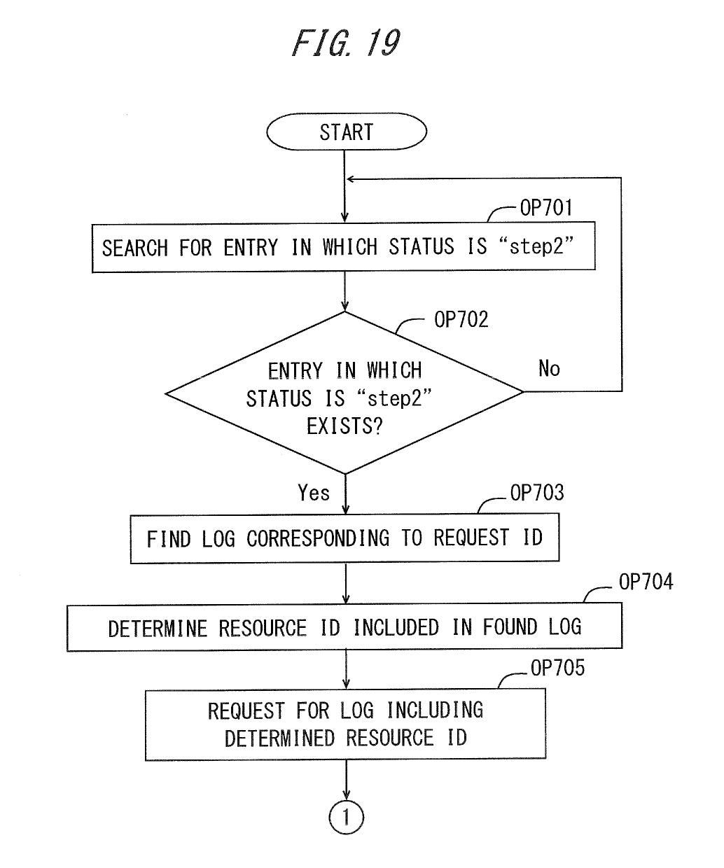

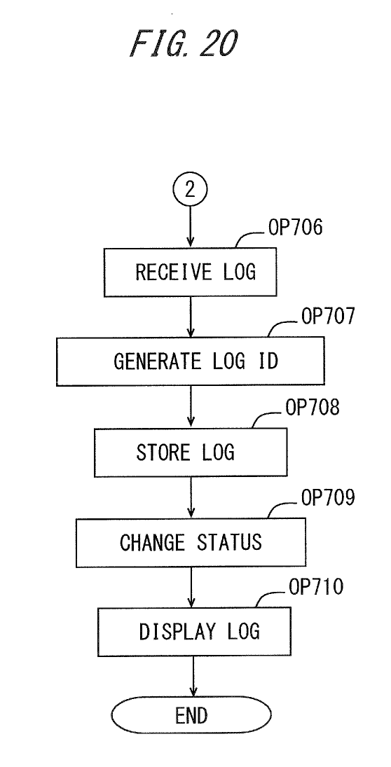

Next, FIGS. 19 and 20 illustrate examples of flowcharts of processes executed by the CPU 201 of the management server 2. The CPU 201 of the management server 2 executes the processes in FIGS. 19 and 20 separately from the processes in FIGS. 12, 13, 15 and 16. Alternatively, the CPU 201 of the management server 2 can execute the processes in FIGS. 12, 13, 15, 16, 19 and 20 in parallel.

In OP701, the CPU 201 searches the log reception status management table for an entry in which the “status” column is “step2”. Next, in OP702, the CPU 201 determines whether an entry in which the “status” column is “step2” exists in the log reception status management table. When an entry in which the “status” column is “step2” exists (OP702: Yes), the process proceeds to OP703. On the other hand, when an entry in which the “status” column is “step2” does not exist (OP702: No), the CPU 201 returns the process to OP701.

In OP703, the CPU 201 searches the log management table for a log corresponding to the request ID for which the CPU 201 determines in OP702 that the “status” column is “step2”. Next, in OP704, the CPU 201 determines a resource ID included in the log found in OP703. In the present embodiment, a resource corresponding to the resource ID determined in OP704 can be regarded as a resource which is related to the process indicated by the request ID corresponding to the log found in OP703.

Next, in OP705, the CPU 201 requests the server 3 and the server 4 for a log which includes the resource ID determined in OP704. And the agents in the server 3 and the server 4 execute the processes similar to the processes in the flowchart in FIG. 14. In the present embodiment, the agents in the server 3 and the server 4 execute receive from the management server 2 the request for a log which includes the resource ID determined in OP704 (OP401) and determine whether a log which includes the requested resource ID exists (OP402). And when the log which includes the requested resource ID exists, the agents in the server 3 and the server 4 transmit the log to the management server 2 (OP403).

Next, the CPU 201 of the management server 2 functions as a log acquiring unit in OP 706 to receive the log requested in OP705, and the process proceeds to OP707. In OP707, the CPU 201 uses messages included in the received log to generate a hush value and determines the generated hush value as a log ID for the received log. Next, in OP 708 similar to OP307, the CPU 201 stores the information included in the log received in OP706 and the log ID generated in OP707 in the log management table.

Further, in OP709, the CPU 201 changes the status of the “status” column for the entry corresponding to the request ID for which the CPU 201 determines in OP702 that the “status” column is “step2” from “step2” to “completed”. It is noted that the status “completed” indicates that the management server 2 has acquired from a server in the information processing system 1 a log related to a failure occurred in the information processing system 1. Next, in OP710, the CPU 201 displays information of the log stored in the log management table in OP708 on the monitor 207.

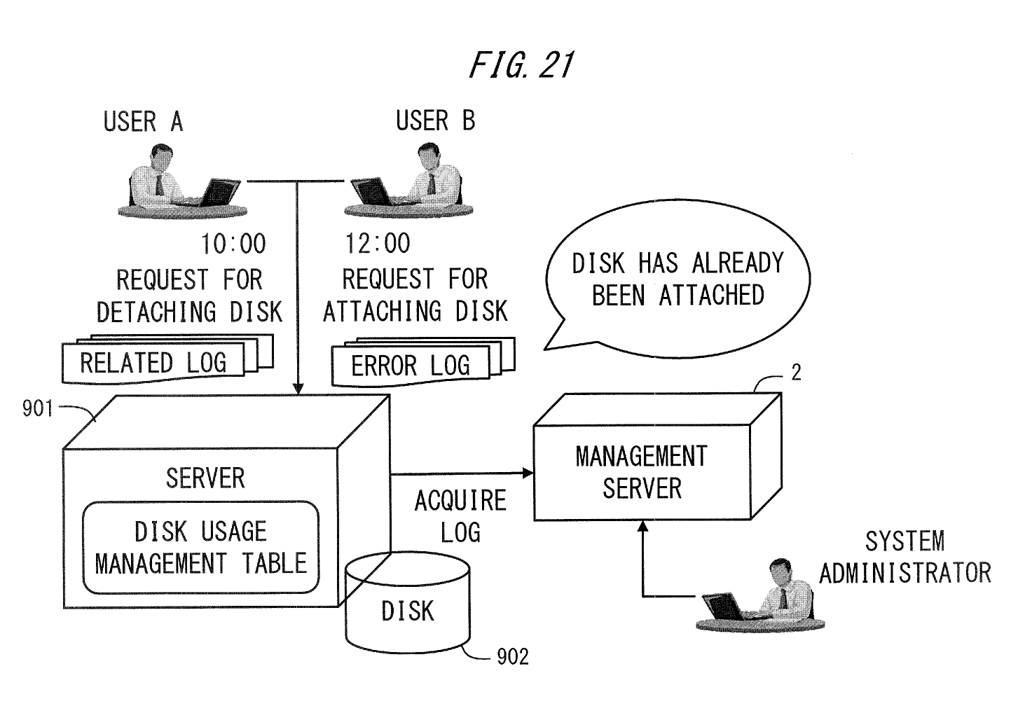

FIG. 21 illustrates an example of a case in which the processes in FIGS. 14, 19 and 20 are executed and the management server 2 acquires a log. In the example in FIG. 21, the information processing system 1 includes a server 901, a disk 902 and the management server 2. In addition, the server 901, the disk 902 and the management server 2 are examples of resources. A resource ID is attached to each of the server 901, the disk 902 and the management server 2.

First, the user A requests at 10:00 for detaching the disk 902 from the server 901. However, in the present example, the process for detaching the disk 902 from the server 901 is not completed normally. Thus, the disk 902 is not detached from the server 901 at this stage. In addition, since the user A does not have a plan to use the disk 902 again, the user A leaves the state in which the disk 902 is not detached from the server 901 and the user A does not report the state to the system administrator of the management server 2. It is assumed here that the server 901 retains a disk usage management table in which various usages of the disk 902 including a status in which the disk 902 is or is not detached from the server 901 are recorded.

In the situation as described above, the user B checks the disk usage management table stored in the server 901 to confirm that the disk 902 is detached from the server 901. In addition, the user B requests at 12:00 for attaching the disk 902 be to the server 901. However, since the disk 902 has not been detached from the server 901, the server 901 outputs a log of an error which reports that “the disk 902 has already been attached to the server 901” when the server 901 processes the request from the user B for attaching the disk 902 to the server 901. In addition, it is assumed here that the user B has not performed any operations to the server 901 before 12:00.

In this case, when the processes in FIGS. 14, 19 and 20 are executed, the management server 2 acquires from the server 901 the error log which indicates that “the disk 902 has already been attached to the server 901”. In addition, the management server 2 acquires from the server 901 a log including the resource ID of the disk 902, that is, a log of the process for detaching the disk 902 from the server 901 according to the request from the user A. In the present example in FIG. 21 as described above, a log regarding a resource related to a process in a failure occurred in the server 901 can be acquired. Namely, the management server 2 can acquire a log regarding a resource related to a failure.

Although specific embodiments are described above, the configurations of the servers etc. described and illustrated in each example can be arbitrarily modified and/or combined. For example, it is assumed in the above embodiments that the management server 2, the server 3 and the server 4 execute the processes in FIGS. 13 and 14, and then execute the processes in FIGS. 15 to 17, and further execute the processes in FIGS. 14, 19 and 20. However, in a variation, the management server 2, the server 3 and the server 4 can be configured not to execute the processes in FIGS. 14, 19 and 20 after the management server 2, the server 3 and the server 4 execute the processes in FIGS. 15 to 17. In this variation, the process in OP511 is changed to a process for changing the status in the “status” column from “step1” to “completed”.

In another variation, the processes in FIGS. 15 to 17 can be omitted, and the management server 2, the server 3 and the server 4 can be configured to execute the processes in FIGS. 14, 19 and 20 without executing the processes in FIGS. 15 to 17 after the management server 2, the server 3 and the server 4 execute the processes in FIGS. 13 and 14. In this variation, the process in OP308 is changed to a process for changing the status in the “status” column from empty to “step2”.

Moreover, the CPU as described above is not limited to a single processor but can be configured as multiple processors. In addition, the CPU can be configured as a multi-core processor and each CPU is connected via a single socket with each other. A part or the whole of the processes can be executed by a Digital Signal Processor (DSP), a Graphics ProcessingUnit (GPU), a numerical processor, a vector processor, a dedicated processor such as an image processing processor. Furthermore, at least a part of the elements in the above embodiment can be an Integrated Circuit (IC) or a digital circuit. Moreover, an analog circuit can be also used in at least a part of the elements in the above embodiment. The IC includes a Large Scale Integration (LSI), an Application Specific Integrated Circuit (ASIC), and a Programmable Logic Device (PLD). The PLD includes a Field-Programmable Gate Array (FPGA). The above parts can be a combination of a processor and an IC. The combination is referred to as Micro-Controller Unit (MCU), System-on-a-Chip (SoC), system LSI and chipset etc.

<<Computer Readable Recording Medium>>

It is possible to record a program which causes a computer to implement any of the functions described above on a computer readable recording medium. In addition, by causing the computer to read in the program from the recording medium and execute it, the function thereof can be provided.

The computer readable recording medium mentioned herein indicates a recording medium which stores information such as data and a program by an electric, magnetic, optical, mechanical, or chemical operation and allows the stored information to be read from the computer. Of such recording media, those detachable from the computer include, e.g., a flexible disk, a magneto-optical disk, a CD-ROM, a CD-R/W, a

DVD, a DAT, an 8-mm tape, and a memory card. Of such recording media, those fixed to the computer include a hard disk and a ROM. Further, a Solid State Drive (SSD) can be used as a recoding medium which is detachable from the computer or which is fixed to the computer.

According to one aspect, it is provided an information processing apparatus for efficiently gathering logs for analyzing a failure which occurs during processes executed by nodes.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information processing apparatus configured to acquire logs regarding processes executed by a plurality of nodes, the information processing apparatus comprising:
memory;
a processor coupled to the memory and configured to execute:
receiving identification information for identifying the processes;
acquiring from the plurality of nodes first time information including time when a first process of the processes indicated by the received identification information is executed and time when a failure occurs during the first process; and
acquiring from the plurality of nodes a first log regarding a process different from the first process, the first log being generated during a time period determined based on the time when the first process is executed and the time when the failure occurs during the first process.

2. The information processing apparatus according to claim 1, wherein the processor is configured to further execute:
acquiring from the plurality of nodes resource information regarding a resource related to the first process; and
acquiring from the plurality of nodes a second log regarding a process different from the first process, the second log including information regarding the resource indicated by the resource information.

3. The information processing apparatus according to claim 1, wherein the processor is configured to further execute:
acquiring the first time information from the plurality of nodes after time longer than timeout period of a process executed by the plurality of nodes elapses.

4. An information processing apparatus configured to acquire logs regarding processes executed by a plurality of nodes, the information processing apparatus comprising:
memory;
a processor coupled to the memory and configured to execute:
receiving identification information for identifying the processes;
acquiring from the plurality of nodes first resource information regarding a first resource related to a first process of the processes indicated by the received identification information; and
acquiring from the plurality of nodes a first log regarding a process different from the first process, the first log including information regarding the first resource.

5. The information processing apparatus according to claim 4, wherein the processor is configured to further execute:
acquiring the first resource information from the plurality of nodes after time longer than timeout period of a process executed by the plurality of nodes elapses.

6. A method of controlling an information processing apparatus configured to acquire logs regarding processes executed by a plurality of nodes, the method comprising:
causing a processor of the information processing apparatus to execute:
receiving identification information for identifying the processes;
acquiring from the plurality of nodes first time information including time when a first process of the processes indicated by the received identification information is executed and time when a failure occurs during the first process; and
acquiring from the plurality of nodes a first log regarding a process different from the first process, the first log being generated during a time period determined based on the time when the first process is executed and the time when the failure occurs during the first process.

7. The method according to claim 6, further comprising:
causing the processor to further execute:
acquiring from the plurality of nodes resource information regarding a resource related to the first process; and
acquiring from the plurality of nodes a second log regarding a process different from the first process, the second log including information regarding the resource indicated by the resource information.

8. The method according to claim 6, further comprising:
causing the processor to further execute:
acquiring the first time information from the plurality of nodes after time longer than timeout period of a process executed by the plurality of nodes elapses.

9. A non-transitory computer-readable recording medium storing a program that causes an information processing apparatus configured to acquire logs regarding processes executed by a plurality of nodes to execute:
receiving identification information for identifying the processes;
acquiring from the plurality of nodes first time information including time when a first process of the processes indicated by the received identification information is executed and time when a failure occurs during the first process; and
acquiring from the plurality of nodes a first log regarding a process different from the first process, the first log being generated during a time period determined based on the time when the first process is executed and the time when the failure occurs during the first process.

10. The non-transitory computer-readable recording medium according to claim 9, wherein the information processing apparatus further executes:
acquiring from the plurality of nodes resource information regarding a resource related to the first process; and
acquiring from the plurality of nodes a second log regarding a process different from the first process, the second log including information regarding the resource indicated by the resource information.

11. The non-transitory computer-readable recording medium according to claim 9, wherein the information processing apparatus further executes:
acquiring the first time information from the plurality of nodes after time longer than timeout period of a process executed by the plurality of nodes elapses.
